(19) United States
(12) Patent Application Publication
(10) Pub. No.: US 2016/0124697 A1
(43) Pub. Date: May 5, 2016

(54) DISPLAY CONTROLLER FOR PERSISTENT DISPLAY PANEL

(71) Applicants: Mingle Sun, Shanghai (CN); Huan Li, Austin, TX (US)

(72) Inventors: Mingle Sun, Shanghai (CN); Huan Li, Austin, TX (US)

(21) Appl. No.: 14/677,932

(22) Filed: Apr. 2, 2015

(30) Foreign Application Priority Data
Nov. 4, 2014 (CN) 201410813706.X

(51) Int. Cl. G06F 3/14

(52) U.S. Cl. CPC G06F 3/1415

(57) ABSTRACT

A display device has a display controller and a persistent display panel for displaying static images. The display controller has a pre-processor that extracts data for updating a frame of the display from a memory module storing display data and compresses the data. A frame buffer stores the compressed data. A display driver receives and de-compresses the compressed data from the frame buffer and repeatedly refreshes the display panel while updating the displayed frame.

### BACKGROUND OF THE INVENTION

The present invention is directed to electrophoretic displays and, more particularly, to a display controller for an electrophoretic display.

Persistent display panels are widely used in e-readers. An e-reader is a portable, battery-powered electronic device that is particularly adapted to reading text, with or without images. An e-reader should have good readability in bright ambient light, even sunlight, and very low power consumption so that it has a very long battery life, e.g., a week or more.

For displaying video or games, a frame of data displayed is continuously refreshed at a rate of 50 Hz to 200 Hz or more. However, in an e-reader, the image of the page displayed is static and does not change while the page is read. Thus, continuously updating the displayed page in an e-reader at such a fast frame refresh rate is unnecessary, and would drain the battery unnecessarily fast.

A persistent display panel is unable to display motion pictures but is well adapted to displaying the static image of a page. Persistent display panels have low power consumption while the image is unchanged, which is an important advantage in an e-reader.

A commonly used technology for a persistent display panel is e-paper, which electronically generates an image that mimics a traditional printed ink page. The image reflects ambient light giving high contrast and a wide reading angle. An example of e-paper technology is an electrophoretic display, which can hold an unchanging image of text or a picture almost indefinitely with negligible power consumption. An electrophoretic display has pigmented particles in suspension, usually in micro-capsules between two plates bearing arrays of electrodes. Voltages applied to the electrodes produce electrical fields of pixel size that re-arrange the pigmented particles to update the image displayed.

A persistent display panel consumes very little power while the image is unchanged. However, building up the display of the new image can be slow, and a ghost of the previous image may persist after the frame is updated. A common technique for reducing these concerns is to rapidly repeat the frame refresh many times during the image update. It would be advantageous to have a method of quickly displaying a new page on an electrophoretic display without ghosting.

### BRIEF DESCRIPTION OF THE DRAWINGS

The present invention, together with objects and advantages thereof, may best be understood by reference to the following description of embodiments thereof shown in the accompanying drawings. Elements in the drawings are illustrated for simplicity and clarity and have not necessarily been drawn to scale.

FIG. 1 is a schematic block diagram of a conventional display controller for a persistent display panel; and

FIG. 2 is a schematic block diagram of a display controller for a persistent display panel in accordance with an embodiment of the present invention.

### DETAILED DESCRIPTION

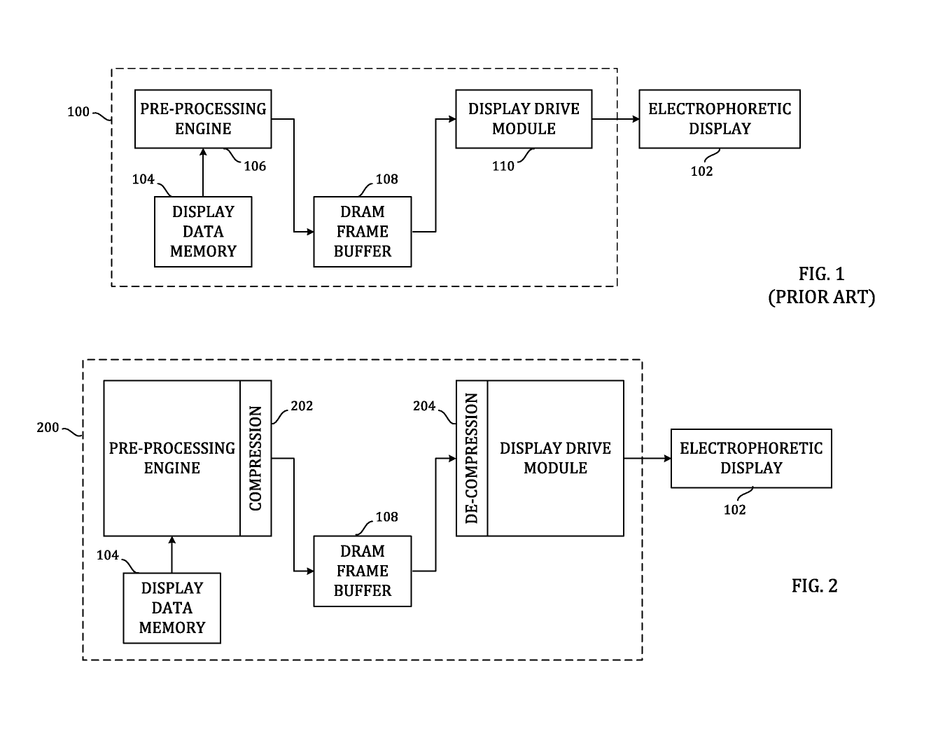

FIG. 1 illustrates a conventional display controller 100 for a persistent display panel 102. The display panel 102 may be a commercially available electrophoretic panel such as an “e-Ink” display panel. The panel 102 and controller 100 may be included in an e-reader for displaying static images such as text and pictures.

The display controller 100 has a memory 104 for storing data to be displayed. A pre-processing engine 106 is coupled to the memory 104 and reads data for updating a frame of the display panel 102. A frame buffer 108 is coupled to the pre-processing engine 106 for storing the data for updating the frame of the display panel 102. Conveniently, the frame buffer 108 (and the memory 104) is a dynamic random access memory (DRAM), which is capable of writing and reading its data rapidly. A display driver 110, including a panel scan engine, reads the data from the DRAM frame buffer 108 and updates the data being displayed on the panel 102.

To update the display, the display controller 100 applies the drive voltages to the panel 102 for each frame in sequence. To ensure a clean update of the frame displayed, and avoid partial updating with persistence of any ghost of the previous image, for example the previous page of an e-book, at each frame update the display driver 110 reads the frame data from the DRAM frame buffer 108 many times and refreshes the display on the panel 102 many times for a single frame. For example, the frame data may be read and the display refreshed ten to twenty times at each frame update. The volume of frame data in the DRAM frame buffer 108 is large and the capacity of the DRAM memory needed for the buffer is costly. The volume of frame data to be read from the DRAM frame buffer 108 for each frame update is also large, requiring fast DRAM input/output (I/O), such as double data rate (DDR) memory, which increases its cost further. The power consumption of the DDR memory and of the DRAM I/O controller is high because of the volume of data and because of the high I/O frequencies required. If the DRAM is shared with other hardware engines, such as a graphics processing unit (GPU), there is a risk of display underrun.

By way of example, if the image displayed on the display panel 102 has N×M pixels and each pixel has P Bytes (depending on whether it is a grey-scale or color image), the size of the frame in the buffer 108 is N×M×P Bytes. For an extended graphic array (XGA) image having 1024×768 pixels and 2 Bytes per pixel, the size of the frame in the buffer is 1024×768×2=1.5 MB. If the display drive module 110 reads the frame updating data from the DRAM frame buffer 108 at a frequency of 50 Hz for ten to twenty times at each frame refresh, with a blanking interval of 20%, the bandwidth used is 1.5 MB×50 Hz/0.8=93 MB/s. Increased panel size, resolution and refresh rate are projected, for example for a panel size of 2048×1536 and 2 bytes/pixel, the size of the frame in the buffer is 6.3 MB; for a refresh rate of 100 Hz, again with a blanking interval of 20%, the bandwidth used is 2048×1536×2×100 Hz/0.8=790 MB/s.

FIG. 2 illustrates a display device in accordance with an embodiment of the present invention having a display controller 200 and a persistent display panel 102 for displaying static images. The display controller 200 comprises a memory module 104 for storing display data. A pre-processor 202 reads data for updating a frame of the display from the memory module 104 and compresses the read data. A frame buffer 108 coupled to the pre-processor 202 is used to store the compressed data. A display driver 204 coupled to the frame buffer 108 receives and de-compresses the compressed data and repeatedly refreshes the display panel 102 while updating a frame of display data.

Compared to the configuration of FIG. 1, the volume of frame data in the DRAM frame buffer 108 is smaller and the capacity of the DRAM memory needed for the buffer is less. The volume of frame data to be read from the DRAM frame buffer 108 for each frame update is reduced, reducing the memory I/O bandwidth needed. The power consumption of the DDR memory and of the DRAM I/O controller is lower because the volume of data and the I/O frequencies required are lower. If a 50% compression rate is used for the first example above of an XGA image having 1024×768 pixels and 2 Bytes per pixel, the size of the frame in the buffer is reduced from 1.5 MB to 0.75 MB, and for a frame refresh frequency of 50 Hz the bandwidth used is reduced from 93 MB/s to 47 MB/s. With the 50% compression rate for the second example above of an XGA image having 2048×1536 pixels, the size of the frame in the buffer is reduced from 6.3 MB to 3.2 MB, and for a frame refresh frequency of 100 Hz the bandwidth used is reduced from 790 MB/s to 395 MB/s.

The display data may be compressed and decompressed by a microcontrol unit (MCU) or other hardware module, or by an algorithm or other software calculation. The display driver 204 may de-compress the display data from the frame buffer 108 on the fly, that is, in real time without intermediate storage of the data.

Compression of video typically uses algorithms and coder-decoders (codecs), such as Moving Picture Experts Group (MPEG) standards, to reduce redundancy in video data and combines spatial image compression and temporal motion compensation. Persistent displays are used to display static images, not motion pictures. The present invention achieves cost and power consumption savings in the display controller 200 for a persistent display displaying static images by compressing the display update data extracted from the memory 104.

Any suitable compression/de-compression technique can be used in the display controller 200, as a function of the desired compression rate and its cost of implementation. However, in the presently preferred embodiment, run-length encoding (RLE) is used. RLE is a form of data compression in which sequences (runs) of display data in which the same data value occurs in many consecutive data elements are stored as a single data value and count, rather than as the original run. RLE is well suited to images of black text on a white background and also for images of more complex pages of a book.

The frame buffer 108 may be any suitable rapidly accessed memory. In the display controller, the frame buffer 108 comprises DRAM. The persistent display panel 102 may also be any suitable technology. In this example, the display panel 102 is an electrophoretic panel.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may be direct connections or indirect connections.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the above described operations merely illustrative. Multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, the word ‘comprising’ or ‘having’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A display controller for a persistent display panel that displays static images, comprising:
a memory module for storing display data;
a pre-processor coupled to the memory module for reading a frame of data from the memory module and compressing read data frame;
a frame buffer coupled to the pre-processor for storing the compressed data; and
a display driver coupled to the frame buffer for receiving and de-compressing the compressed data and repeatedly refreshing the display panel while updating a displayed frame.

2. The display controller of claim 1, wherein the display driver de-compresses the data from the frame buffer on the fly.

3. The display controller of claim 1, wherein compressing and de-compressing use run-length encoding (RLE).

4. The display controller of claim 1, wherein the frame buffer comprises dynamic random access memory (DRAM).

5. A display device having a persistent display panel for displaying static images and a display controller, the display controller comprising:
a memory module for storing display data;
a pre-processor coupled to the memory module for reading data for updating a display frame and compressing the read data;
a frame buffer coupled to the pre-processor for storing the compressed data; and
a display driver coupled to the frame buffer for receiving and de-compressing the compressed data and repeatedly refreshing the display panel while updating a displayed frame.

6. The display device of claim 5, wherein the display driver de-compresses the data from the frame buffer on the fly.

7. The display device of claim 5, wherein compressing and de-compressing use run-length encoding (RLE).

8. The display device of claim 5, wherein the frame buffer comprises dynamic random access memory (DRAM).

9. The display device of claim 5, wherein the persistent display panel comprises an electrophoretic panel.
